(19) United States
(12) Patent Application Publication
(10) Pub. No.: US 2020/0050258 A1
(43) Pub. Date: Feb. 13, 2020

(54) VEHICLE AND WEARABLE DEVICE OPERATION

(71) Applicant: Ford Global Technologies, LLC, Dearborn, MI (US)

(72) Inventors: Pramita MITRA, Bloomfield Hills, MI (US); Yifan CHEN, Ann Arbor, MI (US); Qianyi WANG, Allen Park, MI (US)

(21) Appl. No.: 16/486,003

(22) PCT Filed: Feb. 21, 2017
(86) PCT No.: PCT/US17/18665

§ 371 Date: Aug. 14, 2019

(51) Int. Cl. G06F 3/01; G06F 3/14

(52) U.S. Cl. CPC G06F 3/011; B60K 37/06; G06F 3/14

(57) ABSTRACT

A user sleep score is determined based on user biometric data. An operation that is an action performable based on input on a user device is identified. Based on the operation and the sleep score, a display item is presented on a display of a second computer that is a wearable device.

### BACKGROUND

Vehicles such as passenger cars and the like typically include a human machine interface (HMI) via which occupants can monitor and/or control various vehicle operations. For example, a vehicle HMI typically includes a fixed screen mounted to a vehicle instrument panel and/or center console. Operations monitored or controlled by a vehicle HMI can include climate control, infotainment system control, indicating a destination, and obtaining a route. However, current HMIs can be difficult to access and/or provide input to.

### BRIEF DESCRIPTION OF THE DRAWINGS

FIG. 1 is a block diagram of an example system for operating a wearable device.

FIG. 2 illustrates an example wearable device with a plurality of icons.

FIG. 3 illustrates the wearable device of FIG. 2 with the plurality of icons adjusted based on a sleep score.

FIG. 4 is a block diagram of an example process for displaying the icons on the wearable device.

### DETAILED DESCRIPTION

A system comprises a first computer programmed to determine a user sleep score based on user biometric data, identify an operation that is an action performable based on input on a user device, and, based on the operation and the sleep score, present a display item on a display of a second computer that is a wearable device.

The first computer can be further programmed to actuate a vehicle component based on the sleep score. The sleep score can be based on user movement data. The first computer can be further programmed to present an additional display item upon commencing vehicle navigation along a route. The first computer can be further programmed to adjust a font size of the display item on the display based on the sleep score. The first computer can be further programmed to increase an icon size of the display item on the display based on the sleep score.

The first computer can be further programmed to assign a sleep score threshold for each of a plurality of display items and to present each display item when the sleep score exceeds the sleep score threshold for the respective display item. The first computer can be further programmed to present the display item based on a user location. The first computer can be further programmed to remove the display item when the user location is farther from a vehicle location than a distance threshold. The first computer can be further programmed to present the display item based on user data from a step sensor.

A method comprises determining a user sleep score based on user biometric data, identifying an operation that is an action performable based on input on a user device, and, based on the operation and the sleeps score, presenting a display item on a display of a wearable device.

The method can further comprise actuating a vehicle component based on the sleep score. In the method, the sleep score is based on user movement data. The method can further comprise selecting an additional display item upon commencing vehicle navigation on a route. The method can further comprise adjusting a font size of the display item on the display based on the sleep score. The method can further comprise increasing an icon size of the display item on the display based on the sleep score.

The method can further comprise assigning a sleep score threshold for each of a plurality of display items and to display each display item when the sleep score exceeds the sleep score threshold for the respective display item. The method can further comprise selecting the display item based on a user location. The method can further comprise removing the display item when the user location is farther from a vehicle location than a distance threshold. The method can further comprise selecting the display item based on user data from a step sensor.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

A first computer can be programmed to identify an operation based on a predetermined sleep score of a user. Based on the operation, the first computer can present a display item on a display of a second computer that is a wearable device.

By presenting the icon based on the sleep score of the user, the first computer can enhance the efficiency and/or safety of operating a vehicle based on an attentiveness of the user. The first computer can cause to be presented on the wearable device display icons representing software applications and/or vehicle operations that are more likely useful to the user. That is, a user-desired operation can be predicted based on the data from the vehicle sensors, and the first computer can then identify icons, e.g., for a software application, for an HMI interface representing an operation, etc., that may be presented on the wearable device for user selection during the operation. The first computer can adjust user interface elements of the display on the second (wearable) computer, e.g., an icon size and a font size, so that the user can more easily provide input to the display on the icon. Using the sleep score can improve the likelihood that the first computer will correctly predict performing user's desired operation and an ability and/or efficiency to perform the operation, and can provide the user with an input mechanism, i.e., an icon or the like, that will allow the user to provide input so that the operation can be more efficiently and/or safely performed.

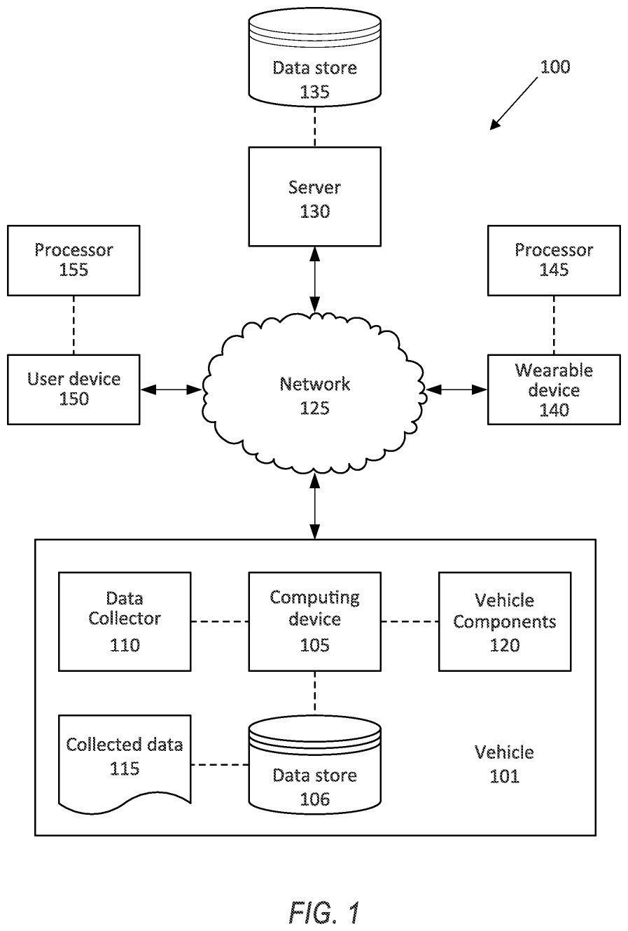

FIG. 1 illustrates an example system 100 for selecting an icon on a display based on a sleep score. A computing device 105 in a vehicle 101 is programmed to receive collected data 115 from one or more sensors 110. For example, vehicle 101 data 115 may include a location of the vehicle 101, a location of a target, etc. Location data may be in a known form, e.g., geo-coordinates such as latitude and longitude coordinates obtained via a navigation system, as is known, that uses the Global Positioning System (GPS). Further examples of data 115 can include measurements of vehicle 101 systems and components, e.g., a vehicle 101 velocity, a vehicle 101 trajectory, etc.

The computing device 105 is generally programmed for communications on a vehicle 101 network, e.g., including a communications bus, as is known. Via the network, bus, and/or other wired or wireless mechanisms (e.g., a wired or wireless local area network in the vehicle 101), the computing device 105 may transmit messages to various devices in a vehicle 101 and/or receive messages from the various devices, e.g., controllers, actuators, sensors, etc., including sensors 110. Alternatively or additionally, in cases where the computing device 105 actually comprises multiple devices, the vehicle network may be used for communications between devices represented as the computing device 105 in this disclosure. In addition, the computing device 105 may be programmed for communicating with the network 125, which, as described below, may include various wired and/or wireless networking technologies, e.g., cellular, Bluetooth®, Bluetooth Low Energy (BLE), wired and/or wireless packet networks, etc.

The data store 106 may be of any known type, e.g., hard disk drives, solid state drives, servers, or any volatile or non-volatile media. The data store 106 may store the collected data 115 sent from the sensors 110.

Sensors 110 may include a variety of devices. For example, as is known, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a location of a target, projecting a path of a target, evaluating a location of a roadway lane, etc. The sensors 110 could also include short range radar, long range radar, LIDAR, and/or ultrasonic transducers.

Collected data 115 may include a variety of data collected in a vehicle 101. Examples of collected data 115 are provided above, and moreover, data 115 are generally collected using one or more sensors 110, and may additionally include data calculated therefrom in the computing device 105, and/or at the server 130. In general, collected data 115 may include any data that may be gathered by the sensors 110 and/or computed from such data. As described below, data 115 can be collected with sensors 110 installed in a wearable device 140 and/or a user device 150.

The vehicle 101 may include a plurality of vehicle components 120. As used herein, each vehicle component 120 includes one or more hardware components adapted to perform a mechanical function or operation—such as moving the vehicle, slowing or stopping the vehicle, steering the vehicle, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, and the like.

The system 100 may further include a network 125 connected to a server 130 and a data store 135. The computer 105 may further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, BLE, IEEE 802.11, vehicle-to-vehicle (V2V) such as Dedicated Short Range Communications (DSRC), etc.), local area networks (LAN) and/or wide area networks (WAN), including the Internet, providing data communication services.

The system 100 may include a wearable device 140. As used herein, a “wearable device” is a portable computing device including a structure so as to be wearable on a person's body (e.g., as a watch or bracelet, as a pendant, etc.), and that includes a memory, a processor, a display, and one or more input mechanisms, such as a touchscreen, buttons, etc., as well as hardware and software for wireless communications such as described herein. A wearable device 140 will be of a size and shape to be fitted to or worn on a person's body, e.g., a watch-like structure including bracelet straps, etc., and as such typically will have a smaller display than a user device 150, e.g., ⅓ or ¼ of the area. For example, the wearable device 140 may be a watch, a smart watch, a vibrating apparatus, etc. that includes capabilities for wireless communications using IEEE 802.11, Bluetooth®, and/or cellular communications protocols. Further, the wearable device 140 may use such communications capabilities to communicate via the network 125 and also directly with a vehicle computer 105, e.g., using Bluetooth®. The wearable device 140 includes a wearable device processor 145.

The system 100 may include a user device 150. As used herein, a “user device” is a portable, non-wearable computing device that includes a memory, a processor, a display, and one or more input mechanisms, such as a touchscreen, buttons, etc., as well as hardware and software for wireless communications such as described herein. That the user device 150 is “non-wearable” means that it is not provided with any structure to be worn on a person's body; for example, a smart phone user device 150 is not of a size or shape to be fitted to a person's body and typically must be carried in a pocket or handbag, and could be worn on a person's body only if it were fitted with a special case, e.g., having an attachment to loop through a person's belt, and hence the smart phone user device 150 is non-wearable. Accordingly, the user device 150 may be any one of a variety of computing devices including a processor and a memory, e.g., a smartphone, a tablet, a personal digital assistant, etc. the user device 150 may use the network 125 to communicate with the vehicle computer 105 and the wearable device 140. For example, the user device 150 and wearable device 140 can be communicatively coupled to each other and/or to the vehicle computer 105 with wireless technologies such as described above. The user device 150 includes a user device processor 155.

The wearable device processor 145 and the user device processor 155 can instruct the computing device 105 to actuate one or more components 120. A user can provide an input to an icon on a wearable device 140 display, e.g., by touching the icon 200. Based on the user input, the wearable device processor 145 can message the user device processor 155 and/or the computing device 105 to actuate the components 120 associated with the input.

The wearable device 140 and/or the user device 150 can determine a sleep score for the user when the user awakens from sleep. As used herein, a “sleep score” is a measure of biometric data 115 of the user, as is known, collected while the user sleeps to determine a quality of the most recent sleep of the user. Example biometric data 115 include, e.g., the user's movement while asleep, heart rate, breathing rate, oxygen level, muscle tension, eye movement, etc. That is, based on the biometric data 155, the wearable device 140 and/or the user device 150 can determine how long the user remains in one or more stages of sleep (e.g., deep sleep, rapid eye movement (REM), etc., as is known) and, based on the length of time spent in each of the stages of sleep, can predict, using known techniques, how rested the user is upon awaking from sleep. The sleep score can be a numerical value between 0 and 100, where 0 indicates a least restful sleep and 100 indicates a most restful sleep. Based on the biometric data 115 collected, using known algorithms, the wearable device 140 and/or the user device 150 can determine a value for the sleep score for the user's most recent period of sleep. For example, the sleep score can be determined based on a length of time that the user remained asleep, e.g., the sleep score upon sleeping more than 6 hours can be greater than the sleep score upon sleeping less than 6 hours.

Based on the biometric data 115, the wearable device processor 145 and/or the user device processor 155 can determine a period of time t during which the user remains in one or more stages of sleep, e.g., deep sleep (DS), light sleep (LS), rapid eye movement (REM), awake, etc., as is known. When the user awakens from sleep, the user can be prompted to provide a user score (e.g., from 1 to 5) to represent the sleep quality. Based on the biometric data 115 and the user score, the wearable device processor 145 and/or the user device processor 155 can use a machine learning model with a linear and/or nonlinear regression function to generate a sleep score prediction equation, e.g., Sleep Score=ƒ₁(t_{DS})+ƒ₂ (t_{LS})+ƒ₃(t_{REM})+ƒ₄(t_{awake}), where ƒ₁−ƒ₄ are known functions. Based on the sleep score equation and the biometric data 115, the wearable device processor 145 and/or the use device processor 155 can generate a sleep score for the user when the user awakens.

Thus, the sleep score can predict the attentiveness of the user upon awaking and during an early portion of the user's day, e.g., during a work commute. For example, if the sleep score is below a first threshold, the user may be less attentive than if the sleep score is above the first threshold. The sleep score can be used by the wearable device processor 145 and/or the user device processor 155 to determine one or more display items to display on a wearable device display 160. As described below, the wearable device processor 145 and/or the user device processor 155 present display items that are predicted to be noticed by the user based on the sleep score. Alternatively or additionally, the sleep score can be determined with a separate device programmed to determine the sleep score other than the wearable device 140 and the user device 150.

The user device processor 155 and/or the wearable device processor 145 can be programmed to determine a display item for the determined operation. In this context, an “operation” is an action or a plurality of actions that a user, a vehicle 101, and/or one or more components 120 thereof could perform based on input from the user device 150 and/or wearable device 140. A predicted operation is on that the user is likely to select based on the data 115. Example operations include, but are not limited to, purchase fuel, purchasing food and beverages, adjusting an entertainment system, moving to a specific destination, adjusting a climate control system, displaying a text notification, etc. For example, data 115 regarding locations of the vehicle 101, location of the user, status of vehicle 101 components 120, and the times corresponding to the locations can indicate what the user did at the locations. In the examples provided below, the system 100 is described such that the user device processor 155 is programmed to determine the display item for the determined operation. Alternatively or additionally, the wearable device processor 145 can be programmed to perform at least some steps in addition to or in lieu of the user device processor 155. A “display item” in the context of this disclosure is an icon representing a software application and/or process (collectively, software application), or is a message or set of data displayed to a user, e.g., “fuel station in 1 mile,” etc. Display items such as icons (e.g., the icons 200 described below) represent software applications or the like to which the user device processor 155 can direct the user to complete the identified operation. For example, if the operation is purchasing fuel, the software application can be a gas station price aggregator.

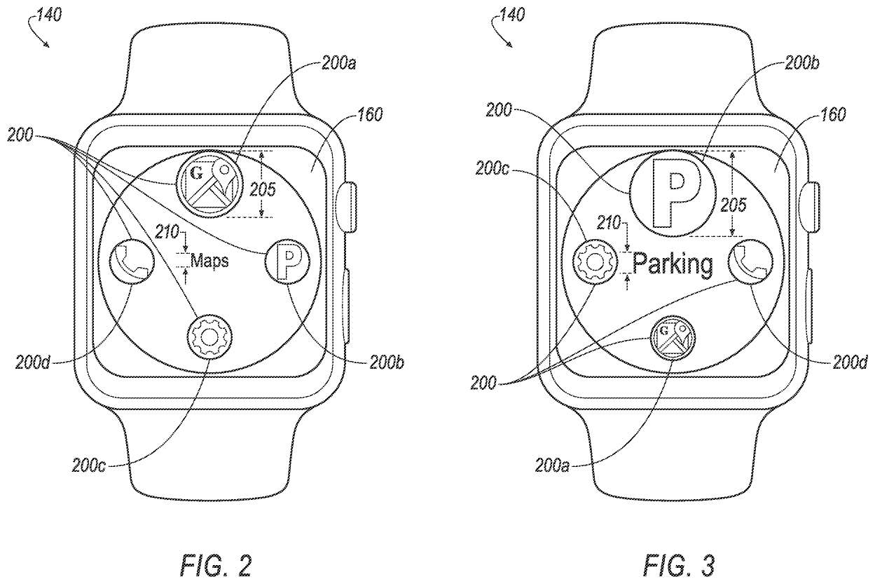

FIG. 2 illustrates an example wearable device 140. The wearable device 140 has a wearable device display 160. The wearable device display 160 can be a touchscreen display that can receive inputs from the user, e.g., a tactile input. The wearable device display 160 can display images and text for the user.

The wearable device processor 145 can be programmed to display a plurality of icons 200 on the wearable device display 160. The icons 200 are images that indicate locations on the wearable device display 160 for the user to provide input. Upon input to one of the icons 200, the wearable device processor 145 can be programmed to, e.g., run a software application. FIG. 2 illustrates 4 icons 200a, 200b, 200c, 200d, and each of the icons 200a-200d is associated with a specific software application. For example, the icon 200a can be associated with a navigation application, the icon 200b can be associated with a parking application, the icon 200c can be associated with a wearable device 140 settings application, and the icon 200d can be associated with a phone call application.

The user device processor 155 can instruct the wearable device processor 145 to present one or more icons 200 on the wearable device display 160 based on one or more identified operations. As used herein, the wearable device processor 145 “presents” the icon 200 when the wearable device processor 145 displays the icon 200 on the wearable device display 160. For example, if the user device processor 155 determines that the operation is purchasing fuel, the user device processor 155 can instruct the wearable device processor 145 to display an icon 200 for a fuel station rewards application, a fuel price aggregator, a navigation application with predetermined locations of nearby fuel stations, etc. In another example, the user device processor 155 can compare the collected data 115 to a predetermined route selected by the user (e.g., in a navigation application), and to present additional icons 200 on the wearable device display 160 based on the predetermined route, e.g., an icon 200 for a fuel station near the route, an icon 200 for a coffee shop near the route, etc. The user device processor 155 can be programmed to identify a plurality of operations and to instruct the wearable device processor 145 to present a respective icon 200 for each of the operations.

The user device processor 155 can identify the software application based on a user history. That is, the user device processor 155 can identify software applications used by the user during previous operations to identify one or more software applications for the current operation. For example, the user device processor 155 can identify that, in prior instances of the fuel purchasing operation, the user used the wearable device 140 to use a navigation application to locate a gas station. Based on the user history, the user device processor 155 can identify, for the fuel purchasing operation, to present the icon 200 for the navigation software application on the wearable device display 160. Alternatively or additionally, the user device processor 155 can identify the display item based on, e.g., a predetermined display item from the data store 106 and/or the server 130.

Each operation can have a sleep score threshold associated with the operation. As described above, the sleep score can indicate an attentiveness of the user. That is, a lower sleep score can indicate that the user is less attentive, and certain operations may require a higher level of attentiveness than the current sleep score indicates. When the sleep score is above the sleep score threshold for the operation, the wearable device processor 145 can present the display item associated with the operation on the wearable device display 160.

The user device processor 155 can be programmed to determine a user location. The user device processor 155 can collect data 115 from, e.g., a location sensor 110 in the wearable device 140 to determine the user location. Based on the user location, the user device processor 155 can determine the operation and present the display item on the wearable device display 160. That is, certain operations can be performed only at specific locations, e.g., a fuel station, a coffee shop, etc. Thus, when the user location is within a distance threshold of the specific locations, the user device processor 155 can determine that the operation based on these specific locations. Furthermore, the user device processor 155 can determine a vehicle 101 location that can be used with the user location by the user device processor 155 to determine the operation and present a display item. For example, if the vehicle 101 location is determined to be a strip mall that includes a coffee shop, and the user location is within a distance threshold of the coffee shop, the user device processor 155 can determine that the operation is purchasing coffee and can present a display item for a coffee shop rewards application. Furthermore, if the sleep score is above a threshold, the user device processor 155 can determine that the user may not require coffee and can determine not to present and/or remove the display item for the coffee shop rewards application. Based on the sleep score, the user device processor 155 can present and/or remove one or more display items from the wearable device display 160.

The user device processor 155 can compare the user location and the vehicle 101 location. When the user location is farther from the vehicle 101 location than a predetermined threshold, the user device processor 155 can remove a display item from the wearable device display 160. For example, if the user device processor 155 has displayed a display item for a parking application, when the user location is farther from the vehicle 101 location than the threshold, the user device processor 155 can determine that the user has already parked the vehicle 101 and remove the display item for the parking application from the wearable device display 160.

The user device processor 155 can determine display items based on a predetermined route of the vehicle 101. Based on previously visited locations of the vehicle 101 (e.g., a stored “work” location, a stored “home” location, etc.), the user device processor 155 can determine a route for the vehicle 101 to navigate to the location. Based on the sleep score, the user device processor 155 can determine one or more operations that can be performed while navigating the route. For example, the user device processor 155 can identify a coffee shop along the route and present a display item on the wearable device display 160. Based on the sleep score, the user device processor 155 can display an additional display item for an additional function on the wearable device display 160 prior to the user commencing navigation of the route. For example, when the sleep score is below a sleep score threshold, the user device processor 155 can determine that the user is more tired than on previous navigations of the route and can present a display item for the coffee shop prior to commencing navigation of the route. Furthermore, the user device processor 155 can remove one or more display items based on the sleep score, e.g., a text notification can be removed when the sleep score is below the sleep score threshold, indicating that the user may be too tired to respond to the text notification.

Each icon 200 can have a specified icon size 205. The icon size 205 is a specified length of the icon 200, e.g., a diameter of a circularly-shaped icon 200, a side length of a square-shaped icon 200, a height of a triangularly-shaped icon 200, etc. Based on the sleep score, the wearable device processor 145 can adjust the icon size 205. For example, if the sleep score is below a first threshold, the wearable device processor 145 can display the icon 200 at a first icon size 205. Then, if the sleep score is above the first threshold, the wearable device processor 145 can display the icon 200 at a second icon size 205. Each operation can include a plurality of predetermined icon sizes 205 based on a plurality of sleep score thresholds.

The display item can have a font size 210. The display item can include text, e.g., the text for “Maps” as shown in FIG. 2 and the text for “Parking” as shown in FIG. 3. The text can describe the operation of the icon 200 at the twelve o'clock position, e.g., the map icon 200a in FIG. 2. Based on the sleep score, the wearable device processor 145 can adjust the font size 210 of the text of the display item. For example, the font size 210 of the text in FIG. 3 on the wearable device display 160 is larger than the font size 210 of the test in FIG. 2. Each display item can have a plurality of predetermined font sizes 210 that can be selected based on the sleep score.

Based on the operation and the sleep score, the user device processor 155 can instruct the wearable device processor 145 to present one of the icons 200 on the wearable device display 160 for the user. For example, if the identified operation is navigating the vehicle 101, the user device processor 155 can instruct the wearable device processor 145 to display the icon 200a near a top of the wearable device display 160 and/or to increase an icon size 205 of the icon 200a. By moving the icon 200a near the top of the wearable device display 160 and increasing the icon size 205 of the icon 200a, the user is more likely to notice the icon 200a and provide input to the icon 200a when the sleep score indicates that the user may be less attentive.

Based on the data 115, the user device processor 155 can determine that one of the previously determined operations is complete, i.e., is no longer an operation. For example, if the operation is purchasing fuel, the user device processor 155 can determine the operation is complete upon receiving data 115 from a fuel sensor 110 indicating that the fuel level is above a fuel level threshold. Upon determining that one of the operations is complete, the user device processor 155 can instruct the wearable device processor 145 to remove the respective icon 200 for the completed operation.

The user device processor 155 can determine the operation based on data 115 from a step sensor 110 in the wearable device 140. The step sensor 110 can determine a number of steps that the user has taken. Based on the number of steps and a user location, the user device processor 155 can determine an operation and present a display item on the wearable device display 160. For example, if the step sensor 110 data 115 and location data 115 indicate that the user is walking toward a coffee shop, the user device processor 155 can determine that the operation is purchasing coffee and can present a display item for a coffee shop rewards application on the wearable device display 160. The user device processor 155 can use the step sensor 110 data 115 in addition to the sleep score to determine an operation, e.g., presenting the display item for the coffee shop rewards application when the sleep score is below a threshold and the step senor 110 data 115 indicate that the user has taken fewer steps than a predetermined average number of steps for a specific time of day.

FIG. 3 illustrates the wearable device processor 145 having adjusted the wearable device display 160 to show a different arrangement of icons 200 from the arrangement shown in FIG. 2. As the user device processor 155 collects data 115 from the sensors 110 in the vehicle 101, the user device processor 155 can determine that the user's desired operation has changed. For example, if the data 115 from a fuel level sensor 110 indicates that the fuel level has increased, the user device processor 155 can determine that purchasing fuel is no longer the current operation and can determine a new operation for the user.

In the example of FIG. 3, based on the sleep score, the user device processor 155 instructs the wearable device processor 145 to rearrange the icons 200a-200d so that the parking icon 200b (which was at the three o'clock position in FIG. 2) is near the top of the wearable device display 160, e.g., at the twelve o'clock position. Furthermore, the user device processor 155 can instruct the wearable device processor 145 to rearrange other icons 200a-200d, e.g., the phone icon 200d (which was at the nine o'clock position in FIG. 2) is at the three o'clock position in FIG. 3, and the settings icon 200c (which was at the six o'clock position in FIG. 2) is at the nine o'clock position in FIG. 3. That is, in the example of FIGS. 2-3, the icons 200a-200d can be arranged according to a predetermined priority, where the priority is, e.g., an ordinal value that indicates a likelihood that the user will provide input to the respective icons 200a-200d. The user device processor 155 can display the icon 200a-200d with the highest priority at the 12 o'clock position and display the other icons 200a-200d in descending order of priority clockwise around the wearable device display 160. The user device processor 155 can, additionally or alternatively, increase the icon size 205 of the icon 200b and decrease the icon size 205 of the icon 200a, as shown in FIG. 3. That is, in the example of FIG. 3, the user device processor 155 determines that the sleep score is above a threshold, and instructs the wearable device processor 145 to present the icon 200b on the wearable device display 160 and to increase the icon size 205 of the icon 200b. As the user device processor 155 collects more data 115, the user device processor 155 can update the determined operation and instruct the wearable device processor 145 to present other icons 200 according to the determined operation.

The user device processor 155 can determine the icon size 205 and the font size 210 (as well a brightness and contrast of the wearable device display 160) based on a predetermined lookup table, e.g.:

| Sleep Score | Font Size | Display Brightness | Display Contrast |
|---|---|---|---|
| 0-30 | 12 pt | 50% | Normal |
| 31-50 | 16 pt | 70% | High |
| 51-100 | 20 pt | 90% | Extra High |

The user device processor 155 can collect data 115 about a usage of each icon 200 based on the sleep score. That is, the user device processor 155 can record the sleep score when the user provides input to each icon 200. Thus, the user device processor 155 can have a plurality of sleep score values associated with each icon 200. Based on the plurality of sleep score values, the user device processor 155 can determine a range of the sleep score for each icon 200. The range has a lower bound R_{low} and an upper bound R_{high}. The lower bound R_{low} is determined by taking a mean range R_{μ} (i.e., a mean of the plurality of sleep scores for the icon 200) and subtracting a standard deviation R_{σ} (i.e., a standard deviation of the plurality of sleep scores for the icon 200), i.e., R_{low}=R_{μ}−R_{σ}. The upper bound R_{high} is determined by adding the mean range R_{μ} to the standard deviation R_{σ}, i.e., R_{high}=R_{μ}+R_{σ}. Thus, the range [R_{low}, R_{high}] represents the spread of sleep scores for a particular icon 200.

Prior to embarking on a trip, the user device processor 155 can prepare a list of icons 200 based on operations performed by the user on previous trips. As used herein, a “trip” is a route that a user traverses from an origin location to a destination. The user can use a vehicle 101 to traverse the trip. The user can perform one or more operations when traversing the trip. The icons 200 can be arranged according to a predetermined ranking, e.g., based on a likelihood of use during the trip. The list can then be filtered, i.e., icons 200 can be added and/or removed from the list, based on the current sleep score. For example, the list can be filtered for each icon 200 according to the following formula:

r=[0.6(U_{history})+0.4(Uₚᵣₑᵥ)]·X

where r is a ranking value, U_{history} is the percentage of usage of the icon 200 for trips based on a user history, as described below, Uₚᵣₑᵥ is the percentage of usage of the icon for a predetermined number of trips prior to the current trip (e.g., the previous 5 trips), and X is a Boolean factor based on the destination of the current trip and the current sleep score. Thus, the list can be ranked in descending order of values of r for each icon 200.

As used herein, the user device processor 155 determines the trips to be included in the user history based on the destination of the current trip. If the destination of the current trip is different from the destination of the trips stored in the user device 150, i.e., the destination of the current trip is a new destination, the user device processor 155 defines U_{history} as a usage of the icon 200 on all previous trips, regardless of destination, and further defines X=1. If the destination of the current trip is the same as at least one of the previous trips, the user device processor 155 defines U_{history} as a usage of the icon 200 on the trips that have the same destination as the current trip and defines X as:

$$X = \{ \begin{matrix}1 & when {R}_{low} < Current Sleep Score < {R}_{high} \\ 0 & otherwise\end{matrix}$$

Additionally or alternatively, the user device processor 155 can define U_{history} as a usage of the icon 200 on previous trips having both the same destination and the same origin as the current trip.

In another example, the ranking formula can be

r=0.3(U_{history})+0.4(Uₚᵣₑᵥ)+|R_{μ}−Current Sleep Score|*0.3

where U_{history} and Uₚᵣₑᵥ are defined as described above.

Based on the r values, the user device processor 155 can select a predetermined number N of icons 200 having the highest r values and present them on the wearable device display 160. The predetermined number N of icons 200 can be determined based on statistical data, e.g., a mean number of operations performed by the user on previous trips. Furthermore, the user device processor 155 can instruct the wearable device processor 145 to present the icon 200 with the highest r value at the 12 o'clock position on the wearable device display 160 and display each successive icon 200 in descending r value order clockwise around the wearable device display 160. Additionally or alternatively, the example formulas listed above (including the coefficients used) can be adjusted based on, e.g., data 115 collected by a plurality of users.

The user device processor 155 can reduce the sleep score based on a current time. As the user progresses through the day, the user can become less attentive and operational efficiency can decrease. Thus, the user device processor 155 can apply a time factor Fₜ to reduce the sleep score to account for the loss of attentiveness. Example time factors Fₜ can be:

| Time | 6AM-12PM | 12PM-6PM | 6PM-12AM | 12AM-6AM |
|---|---|---|---|---|
| Fₜ | 1.0 | 0.8 | 0.6 | 0.0 |

The user device processor 155 can be programmed to instruct the wearable device processor 145 to display a notification on the wearable device display 160 based on the operation and the sleep score. The notification can provide information to the user associated with the operation and/or the solution to the operation. For example, if the user device processor 155 identifies the operation as purchasing fuel, the user device processor 155 can instruct the wearable device processor 145 to display a text notification indicating a current fuel level, a location of a nearby fuel station, and an estimated price of fuel at the fuel station. In another example, the user device processor 155 can instruct the wearable device processor 145 to display a calendar entry indicating an appointment on the wearable device display 160.

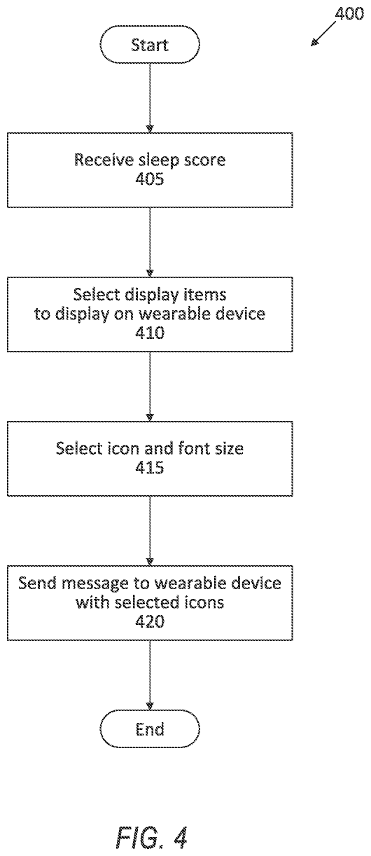

FIG. 4 illustrates a process 400 for selecting display items to display on the wearable device display 160. The process 400 begins in a block 405, in which the user device processor 155 receives the sleep score of the user. As described above, the sleep score can be determined by the wearable device processor 145 and/or a separate sleep tracking device.

Next, in a block 410, the user device processor 155 selects display items (e.g., icons 200) to display on the wearable device display 160. That is, the operation associated with each display item can have a respective sleep score threshold, and when the sleep score exceeds the respective sleep score threshold, the user device processor 155 selects the display item to display on the wearable device display 160.

Next, in a block 415, the user device processor 155 selects an icon size 205 of the display item and a font size 210 for each display item. As described above, based on the sleep score, the user can require a larger icon 200 and/or a larger font size 210 to provide input to the display item. Each display item can have a predetermined icon size 205 and font size 210 based on the sleep score, as shown above. Furthermore, each display item can have a plurality of icon sizes 205 and font sizes 210 that the user device processor 155 can select based on the sleep score.

Next, in a block 420, the user device processor 155 sends a message to the wearable device processor 145 with the selected display item, icon size 205, and font size 210. The wearable device processor 145 then presents the display items on the wearable device display 160 according to the icon size 205 and the font size 210. Following the block 420, the process 400 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices 105 generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a first computer programmed to:
determine a user sleep score based on user biometric data;
identify an operation that is an action performable based on input on a user device; and
based on the operation and the sleep score, present a display item on a display of a second computer that is a wearable device.

2. The system of claim 1, wherein the first computer is further programmed to actuate a vehicle component based on the sleep score.

3. The system of claim 1, wherein the sleep score is based on user movement data.

4. The system of claim 1, wherein the first computer is further programmed to present an additional display item upon commencing vehicle navigation along a route.

5. The system of claim 1, wherein the first computer is further programmed to adjust a font size of the display item on the display based on the sleep score.

6. The system of claim 1, wherein the first computer is further programmed to increase an icon size of the display item on the display based on the sleep score.

7. The system of claim 1, wherein the first computer is further programmed to assign a sleep score threshold for each of a plurality of display items and to present each display item when the sleep score exceeds the sleep score threshold for the respective display item.

8. The system of claim 1, wherein the first computer is further programmed to present the display item based on a user location.

9. The system of claim 8, wherein the first computer is further programmed to remove the display item when the user location is farther from a vehicle location than a distance threshold.

10. The system of claim 1, wherein the first computer is further programmed to present the display item based on user data from a step sensor.

11. A method, comprising:
determining a user sleep score based on user biometric data;
identifying an operation that is an action performable based on input on a user device; and
based on the operation and the sleep score, presenting a display item on a display of a wearable device.

12. The method of claim 11, further comprising actuating a vehicle component based on the sleep score.

13. The method of claim 11, wherein the sleep score is based on user movement data.

14. The method of claim 11, further comprising selecting an additional display item upon commencing vehicle navigation on a route.

15. The method of claim 11, further comprising adjusting a font size of the display item on the display based on the sleep score.

16. The method of claim 11, further comprising increasing an icon size of the display item on the display based on the sleep score.

17. The method of claim 11, further comprising assigning a sleep score threshold for each of a plurality of display items and to display each display item when the sleep score exceeds the sleep score threshold for the respective display item.

18. The method of claim 11, further comprising selecting the display item based on a user location.

19. The method of claim 18, further comprising removing the display item when the user location is farther from a vehicle location than a distance threshold.

20. The method of claim 11, further comprising selecting the display item based on user data from a step sensor.
